(19) United States
(12) Patent Application Publication
(10) Pub. No.: US 2017/0355831 A1
(43) Pub. Date: Dec. 14, 2017

(54) METHOD FOR PREPARING A REINFORCED STRUCTURE

(71) Applicants: NEW BATH, Voreppe (FR); RAIGI, Rouvray Saint-Denis (FR)

(72) Inventors: Désiré AUBOURG, Pont Sainte Marie (FR); Augustin BOULMIER, Troyes (FR); Olivier PERRIER, Rouvray Saint Denis (FR); Dominique ROCLE, Fleury les Aubrais (FR)

(73) Assignees: NEW BATH, Voreppe (FR); RAIGI, Rouvray Saint-Denis (FR)

(21) Appl. No.: 15/618,840

(22) Filed: Jun. 9, 2017

Related U.S. Application Data
(60) Provisional application No. 62/348,492, filed on Jun. 10, 2016.

(51) Int. Cl. C08K 3/40; C08G 18/66; C08G 18/32; B29C 39/10; B29C 51/00; C08G 18/48; B29C 70/68; B29C 70/58; C08G 18/10; B29C 39/00; C08K 3/04; B29K 101/12; B29K 105/16; B29L 31/00; B29K 75/00; B29L 7/00; B29K 509/08

(52) U.S. Cl. CPC C08K 3/40; C08K 3/04; C08G 18/6618; C08G 18/3237; B29C 39/10; B29C 51/002; C08G 18/4825; B29C 70/68; B29C 70/58; C08G 18/10; B29C 39/003; B29K 2101/12; B29K 2105/16; B29L 2031/769; B29K 2075/00; B29L 2007/002; B29K 2509/08

(57) ABSTRACT

This invention relates to the use of composite reinforcements advantageously comprising a thermosetting matrix and a filler in particular in the reinforcing of thermoplastic material or of thermosetting resin, in order to obtain a reinforced structure such as a bathtub, a washbasin, a wall panel or a shower tray.

This invention relates more particularly to a method for preparing a reinforced structure using composite reinforcements, as well as the structure able to be obtained by such a method.

### FIELD OF THE INVENTION

This invention relates to the technical field of composite reinforcements advantageously comprising a thermosetting matrix and a filler.

This invention relates more particularly to the use of composite reinforcements with a polyurethane base, in particular in the reinforcing of thermoplastic material or of thermosetting resin, in order to obtain a reinforced structure such as a bathtub, a washbasin, a wall panel or a shower tray.

This invention relates more particularly to a method for preparing a reinforced structure using composite reinforcements, as well as the structure able to be obtained by such a method.

### PRIOR ART

The structures used in the sanitary field, such as bathtubs, washbasins or shower trays, were conventionally made of ceramic, enamelled cast iron or steel. The problem coming from these materials used was linked to the substantial weight of the latter resulting in great difficulties for installation or transport. These materials were also able to be damaged easily during impacts.

It was therefore proposed in prior art to create structures with a synthetic resin base, such as resins with a polyester or polyurethane base. In order to improve the mechanical properties, these resins have to be mixed with a mineral filler, such as marble powder, silica or calcium carbonate. During industrialisation, a specific mixing machine must then be used in order to be adapted to the filler chosen. The investment associated with this mixing machine, as well as the maintenance costs generally represent a substantial amount.

The most commonly used resin is the resin with a polyester base containing styrene, with the latter having a price that is much lower than resins with a polyurethane base. However, styrene is a Volatile Organic Compounds (VOC) classified in the group 2B (i.e. potentially carcinogenic).

With regards to polyurethane resins that are expensive, it is common to increase the percentage of the mineral filler in the resin in order to decrease the final cost of the products. This however has for effect to render the product heavier and more brittle.

Moreover, the synthetic resins used are not self-smoothing when they are applied, and it is therefore mandatory to use specific tools in order to correctly spread out the material in the mould. In addition, after polymerisation of the resin+added filler unit, it is sometimes necessary to pass the product through machining in order to adjust the flatness of the structure.

In addition to the disadvantages mentioned hereinabove, the structures created using synthetic resin, such as shower trays have difficulties in being compliant with the technical tests according to standard NF EN249. This standard imposes that the shower tray withstands a thermal shock from 90 to 12° C. (one cycle) followed by a thermal shock from 75 to 12° C. (100 cycles). Due to the excessive quantity of mineral filler added to the resin in order to reduce costs, the trays are less resistant and have cracks during these tests.

It has also been proposed in prior art to manufacture structures using a thermoplastic whereon a polyurethane resin is sprayed. However this technology has many disadvantages, such a very short polymerisation time (about 4 to 5 minutes), a very substantial rise in temperature (up to 115° C.), a deformation of the part if the product is not held correctly and a substantial material scrap rate linked to the spraying.

Consequently, there was a need to develop a method for preparing a structure that does not have the aforementioned disadvantages and that makes it possible to obtain a reinforced structure such as a bathtub, a washbasin, a wall panel or a shower tray, that withstands more mechanical stresses, such as thermal shocks.

This invention proposes to provide such a method.

### SUMMARY OF THE INVENTION

As such, this invention relates to a method for preparing a reinforced structure, such as a thermoplastic material or a thermosetting resin.

This invention also relates to the reinforced structure able to be obtained by the method for preparing according to this invention.

### DESCRIPTION OF THE INVENTION

This invention relates to a method for preparing a reinforced structure comprising the following steps:

a) forming the structure to be reinforced in the form of a receptacle,

b) preparing a liquid thermosetting formulation at ambient temperature using a mixture of thermosetting polymer precursors, said liquid thermosetting formulation having a viscosity between 50 and 2000 mPa·s, preferably between 50 and 600 mPa·s,

c) pouring said liquid thermosetting formulation into said receptacle,

d) adding a filler into said thermosetting formulation poured during the step c), said filler having a granulometry between 0.05 and 10 mm, preferably between 0.1 and 3 mm, a moisture content less than 0.1%, and advantageously having a density greater than the density of said thermosetting formulation,

e) polymerising said thermosetting formulation with said filler, forming as such a reinforced structure, and

f) possibly, pouring a finishing layer constituted of said liquid thermosetting formulation prepared during the step b).

Advantageously, the structure is a thermoplastic material such as PMMA (poly(methyl methacrylate), ABS (acrylonitrile butadiene styrene) or ABS-PMMA (layer of PMMA coextruded on the ABS) or a thermosetting resin, such as a polyurethane or polyester resin, advantageously the structure is a thermoplastic material.

Advantageously, the thermoplastic material is made of PMMA (poly(methyl methacrylate), ABS (acrylonitrile butadiene styrene) or ABS-PMMA (layer of PMMA coextruded on the ABS).

Advantageously, the thermosetting resin is a polyurethane or polyester resin.

Advantageously, when the structure to be reinforced is a thermoplastic material, the forming thereof during the step a), in the form of a receptacle is carried out by thermoforming, according to the techniques and means known to the man skilled in the art. The thermoplastic material, advantageously having the form of a plate, is as such typically heated in order to be softened, and this ductility is taken advantage of in order to form it into the shape of a receptacle with application of a mould. The material hardens during the cooling phase, as such retaining this shape. The receptacle obtained as such therefore corresponds to a flexible plastic skin.

Advantageously, when the structure to be reinforced is a thermosetting resin, the forming thereof during the step a), in the form of a receptacle is carried out according to a method comprising the following steps:

1. application in a negative mould, i.e. hollow, of a layer of an anti-adhesive,

2. spraying using a spray of a thermosetting resin on the inside surface of the negative mould whereon has been applied the anti-adhesive layer, then

3. polymerisation of the resin, advantageously for a duration between 45 and 180 minutes, in order to obtain a receptacle that hugs the shape of the negative mould.

The receptacle obtained as such can therefore be considered as the base of a mould. The anti-adhesive advantageously chosen from release agents of the paste wax, spray or liquid type is used to facilitate the unmoulding of the thermosetting resin applied in the mould for its forming.

Forming the structure to be reinforced in the form of a receptacle makes it possible as such to receive the composite reinforcing material (thermosetting formulation+filler) during later steps c) and d). Forming also makes it possible using a thermoplastic material or a thermosetting resin to give the desired shape to the structure that is sought to be reinforced. The shape given to the thermoplastic material or to the thermosetting resin is advantageously the shape of a bathtub, washbasin, wall panel or shower tray.

Advantageously, when the structure to be reinforced is a shower tray or a wall panel, the entire structure in the form of a receptacle receives the composite material and is as such reinforced. Advantageously, when the structure to be reinforced is a washbasin or a bathtub, typically only a portion of the receptacle received the composite material and is then reinforced, this is typically the edges of the structure.

During the step b), preparing a liquid thermosetting formulation at ambient temperature is carried out using a mixture of at least two precursors of thermosetting polymer. Ambient temperature typically means a temperature between 18° C. and 25° C. The polymerisation reaction starts during the mixing of the precursors and as such allows for the starting of polymerisation of the precursors into a thermosetting polymer. The duration of polymerisation depends on the nature and/or on the quantity of precursors used, as well as on the possible presence of a catalyst and on the nature and on the thickness of the receptacle. Indeed, the thicker the receptacle is, the higher the quantity of thermosetting formulation poured during the step c) will be and the longer the duration of polymerisation will be.

Advantageously, the steps c) and d) are carried out before the complete polymerisation of the liquid thermosetting formulation. As such, the duration of polymerisation can be between 1 and 90 minutes, advantageously between 1 and 60 minutes, in an advantageous manner between 5 and 15 minutes.

Advantageously, the mixture of precursors of thermosetting polymer comprises at least one polyol and at least one isocyanate. Advantageously, the thermosetting polymer is a polyurethane.

According to the invention, the polyol or polyols can be chosen from bio-sourced polyols or from polyols of petroleum origin, in particular from polyether polyols, polyesters, polycaprolactones, polycarbonate diols, hydroxylated polybutadienes, hydroxylated polymers, polyols of natural origin of the castor type or any molecular chain having free hydroxyl links. Advantageously, the polyol or polyols are polyols of natural origin of the castor type.

The polyol or polyols are advantageously formulated according to the techniques and means known to those skilled in the art using a mixture comprising polyols, additives, colouring agents and catalysts.

According to the invention, the isocyanate or isocyanates can be chosen from mono isocyanates, diisocyanates and/or polyisocyanates, such as diphenylmethane diisocyanate (MDI), toluene 2,4- and 2,6-diisocyanate (TDI), isophorone diisocyanate (IPDI), 4,4′-dicyclohexylmethane diisocyanate (H₁₂MDI), 1,6-hexamethylene diisocyanate (HDI), 1,4-cyclohexane diisocyanate (CHDI), bis(isocyanatomethyl)cyclo-hexane (H₆XDI,DDI), tetramethyxylylene diisocyanate (TMXDI), all molecular chains having isocyanate links and mixtures thereof. Advantageously, the isocyanate is diphenylmethane diisocyanate (MDI).

Advantageously, the polyol/isocyanate weight ratio is between 100/10 and 100/300, preferably between 100/40 and 100/80.

Advantageously, the liquid thermosetting formulation prepared during the step b) further comprises a catalyst chosen from amines and metallic salts such as the commercial products DABCO®, JEFFCAT®, POLYCAT®, NIAX®, TOYOCAT® and PC CAT®.

Advantageously, the liquid thermosetting formulation prepared during the step b) further comprises one or several additives chosen from antioxidants (for example pentaerythritol tetrakis(3-(3,5-di-tert-butyl-4-hydroxyphenyl)propionate)), colouring agents (for example the pigment paste of carbon black), surfactants (for example dimethylsiloxane solutions), wetting agents (for example of the polysiloxane type), surface active agents, degassing agents (for example of the silicone type), drying agents and adsorption agents (for example zeolites).

This additive or these additives more preferably represent from 0 to 5% by weight of the liquid thermosetting formulation prepared during the step b).

Advantageously, the liquid thermosetting formulation prepared during the step b) has a density between 0.3 and 2.4, preferably between 1 and 1.25 and a viscosity between 50 and 2000 mPa·s, preferably between 50 and 600 mPa·s, and further preferably between 450 and 550 mPa·s.

The liquid thermosetting formulation has as an advantage to not include COV (no use of resin with a styrene base) or solvent, of being self-smoothing, shiny after polymerisation and to have a strong adherence on thermoplastics and thermosetting resins as such avoiding the use of an adhesion primer.

According to a particular embodiment, a step consisting of applying an adhesion primer on the structure to be reinforced in the form of a receptacle following the step a) upstream of steps b) or c) can be considered when the thermoplastic structure is with a polyolefin base, advantageously with a polyethylene base.

Advantageously, the adhesion primer is an adhesion primer for thermoplastic material chosen from Körabond HG77®, 3M Primaire® and Sika® Aktivator

The mixture of precursors of thermosetting polymer is typically carried out in a standard mixing machine such as a low or high pressure machine sized according to the size of the receptacle able to receive during the step c) said liquid thermosetting formulation formed as such during the step b).

During the step d), a filler is added into thermosetting formulation poured during the step c). In order to be able to sink correctly into the thermosetting formulation, the filler has a density advantageously greater than the density of said thermosetting formulation. The filler must moreover have a moisture content less than 0.1%. Indeed, the presence of water in the filler favours the formation of CO₂ with the isocyanate precursor resulting as such in foaming and an uncontrolled expansion. As the mineral fillers for the most part come from quarries, they have a moisture content that is too high to be able to be used in the method of this invention. Anhydrous mineral fillers such as calcinated kaolin have a granulometry that is too fine and represent a cost that is too high.

A technical advantage of the method according to the invention resides in the fact that the filler is added to the thermosetting formulation already formed using the mixture of precursors in the mixing machine and poured during the step c). Indeed, the adding of the filler outside of the mixing machine makes it possible to use different types of filler without resulting in an extra cost linked to the use of different specific machines.

According to a particular embodiment of the invention, the step d) of adding the filler can be carried out immediately before the step c) of pouring the liquid thermosetting formulation, or immediately before the step b) of preparing this formulation. Indeed, the steps of pouring the thermosetting formulation and of adding the filler can be inverted without consequence on the properties of the reinforced structure obtained.

As such, according to a particular embodiment, the method for preparing a reinforced structure comprises the following steps:

a) forming the structure to be reinforced in the form of a receptacle,

b) adding a filler into said receptacle, said filler having a granulometry between 0.05 and 10 mm, preferably between 0.1 and 3 mm, a moisture content less than 0.1%, and advantageously having a density greater than the density of the thermosetting formulation prepared in parallel,

c) preparing in parallel a liquid thermosetting formulation at ambient temperature using a mixture of thermosetting polymer precursors, said liquid thermosetting formulation having a viscosity between 50 and 2000 mPa·s, preferably between 50 and 600 mPa·s,

d) pouring said liquid thermosetting formulation into said receptacle containing said filler added during the step b),

e) polymerising said thermosetting formulation with said filler, forming as such a reinforced structure, and

f) possibly, pouring a finishing layer constituted of said liquid thermosetting formulation prepared during the step c).

Advantageously the filler has a density greater than the density of said thermosetting formulation and is composed of materials chosen from thermoplastic materials, thermosetting materials, their by-products such as the technical scraps of the latter, wood-meal, glass such as recycled glass and mixtures thereof. Advantageously, the filler used is glass, in particular recycled glass.

The glass, such as recycled glass is advantageously industrial glass such as construction glass (window glass) or automobile glass (windscreen glass) or hollow glass (household glass). The glass coming from recycling is ground, decanted, washed then dried before being able to be added directly without another treatment to the formulation during the step d).

According to a particular embodiment, when the filler used is wood-meal, the granulometry is between 0.09 and 1.25 mm.

According to a particular embodiment, when the filler used is glass, the granulometry is between 0.05 and 10 mm, advantageously between 0.1 and 3 mm.

According to a particular embodiment, when the filler used is chosen from thermoplastic materials, thermosetting materials, their by-products such as scraps, the granulometry is between 8 and 10 mm.

The thermoplastic and thermosetting materials are advantageously added directly to the thermosetting formulation or to the receptacle without undergoing treatment. The by-products of the thermoplastic and thermosetting materials are advantageously technical scraps.

Advantageously, the filler represents between 10 and 60% by weight of the total mass.

The filler is typically added at several points using a filler depositing machine, such as a Gravimax from Wittman. This type of machine is able to deposit different fillers because it has compartments in order to differentiate them. The step e) allows for the polymerisation of the thermosetting formulation with the filler, in order to form a reinforced structure.

In an embodiment, following the adding of the filler during the step d), the receptacle is put into vibration. Advantageously, the vibration is carried out using a vibration table.

In another embodiment, the filler added during the step d) is advantageously scraped over the entire surface of the thermosetting formulation poured in the receptacle, typically using a scraper system (in the form of a comb)

This step of vibration or of scraping makes it possible to provide a homogeneous distribution of all of the filler in the thermosetting formulation.

Optionally, a pouring of a finishing layer of the liquid thermosetting formulation prepared during the step b) can be applied on the reinforced structure formed during the step e) when the viscosity of the latter has reached the gelling threshold. It is considered that the gelling threshold has been reached when the liquid formulation is transformed into gel. One of the methods commonly used by those skilled in the art for defining the gelling threshold consists in using a tip such as a needle, with which the thermosetting formulation in the process of polymerisation is penetrated. When the tip is withdrawn, if there is a string of matter between the tip and the thermosetting formulation in progress of polymerisation it is considered that the material has passed from the liquid state to the gel state and that the gelling threshold has been reached. As such, it is not necessary to wait for complete polymerisation during the step e) to be able to pour the finishing layer. Advantageously, the finishing layer represents between 10 and 30% by weight of the liquid thermosetting formulation poured in the receptacle.

All of the steps of the method of this invention as such make it possible to obtain a reinforced structure in comparison with the structures of prior art.

Advantageously, the reinforced structure is a bathtub, a washbasin, a wall panel or a shower tray or at least one portion of the latter, typically at least one portion of a bathtub or of a washbasin.

According to a particular embodiment, this invention relates to a method for preparing a reinforced structure comprising the following steps:

a) forming the structure to be reinforced in the form of a receptacle,

b) preparing a liquid polyurethane formulation at ambient temperature using a mixture of at least one polyol and of at least one isocyanate, said liquid polyurethane formulation having a viscosity between 50 and 2000 mPa·s, preferably between 50 and 600 mPa·s,

c) pouring said liquid polyurethane formulation into said receptacle,

d) adding a filler into said thermosetting formulation poured during the step c), said filler having a granulometry between 0.05 and 10 mm, preferably between 0.1 and 3 mm, a moisture content less than 0.1%, and advantageously having a density greater than the density of said polyurethane formulation,

e) polymerising said polyurethane formulation with said filler, forming as such a reinforced structure, and

f) possibly, pouring a finishing layer constituted of said liquid polyurethane formulation prepared during the step b).

This invention also relates to the reinforced structure able to be obtained by the method of preparing according to the invention.

Advantageously, the reinforced structure obtained according to the method of this invention is a bathtub, a washbasin, a wall panel or a shower tray or at least one portion of the latter, typically at least one portion of a bathtub or of a washbasin.

### EXAMPLES

### 1. Preparing a Reinforced Structure

The precursors used in the example hereinbelow for preparing polymerisation mixture in accordance with this invention are the following:
GYROTHANE® precursor (registered trademark) of grade 900 or 909, manufactured by RAIGI (supplier), constituted primarily of polyols of the polyether polypropylene glycol type, of aromatic amines, of additives (zeolite), of carbon pigment and of catalyst of the metallic type.
RAIGIDUR® precursor (registered trademark) of grade FPG, manufactured by RAIGI (supplier), constituted of isocyanate of the prepolymer type with a MDI base.

As a simple illustration, a particular example of preparing a shower tray reinforced according to the method of this invention is indicated hereinafter.

a) forming of a thermoplastic material by thermoforming in the form of a receptacle, with the receptacle obtained having the shape of a shower tray,

b) preparing a liquid polyurethane formulation at ambient temperature using a mixture of precursors GYROTHANE® and RAIGIDUR® according to an isocyanate/polyol ratio of 1:1.8, said liquid polyurethane formulation having a viscosity of 550 mPa·s, a density of 1.10 and a polymerisation time of 12 minutes,

c) pouring said liquid polyurethane formulation into said receptacle,

d) adding glass representing 60% of the total weight in said polyurethane formulation poured during the step c), with the glass having a granulometry between 1.5 and 3 mm, a moisture content less than 0.1%, and a density of 2.48,

e) polymerisation of said formulation of polyurethane with the glass, as such forming a reinforced shower tray

### 2. Comparative Example

Table 1 hereinafter shows different comparative tests between shower trays present in commerce and a shower tray reinforced according to the method of this invention.

All of these trays were tested according to the two standards EN 14527 and NF EN 249. For the marketing of shower trays in Europe, it is mandatory to be compliant with standard EN 14527 which consists in carrying out 100 cycles, hot water (75° C.)/cold water (12° C.). For a high level of quality, it is possible to have the label or certification NF for the French market. On this label, it is imperative to be compliant with standard NF EN 249 which consists in carrying out a hot water (90° C.)/cold water (12° C.) cycle before carrying out 100 cycles, hot water (75° C.)/cold water (12° C.)

Table 1 hereinbelow, shows comparative tests of resistance to the variation in temperature according to the standards EN 14527 and NF EN 249, between a tray prepared according to the method of this invention and trays from the market.

TABLE 1

| | Tray | Tray from | Tray from | Tray from | Tray from | Tray from | Tray from |
|---|---|---|---|---|---|---|---|
| | according | the | the | the | the | the | the |
| | to the | market | market | market | market | market | market |
| | invention | no. 1 | no. 2 | no. 3 | no. 4 | no. 5 | no. 6 |
| 100 Cycles | Compliant | Non- | Compliant | Non- | Non- | Non- | Compliant |
| at | | compliant | | compliant | compliant | compliant | |
| 75° C./12° C. | | (Crack | | (Crack | (Crack | (Crack | |
| (NF EN | | after 4 | | after 85 | after 60 | after 1 | |
| 14527) | | cycles) | | cycles) | cycles | cycle) | |
| Cycle at | Compliant | Not | Not | Not | Not | Not | Not |
| 90° C./12° C. | | carried | compliant | carried | carried | carried | Compliant |
| (NF EN | | out | (Crack) | out | out | out | (Crack) |
| 249) | | | | | | | |

The tests carried out have made it possible to observe that a substantial number of shower trays present in the market and supposed to be compliant with standard NF EN 14527 do not in the end satisfy the conditions imposed by this standard. Indeed, trays 1, 3, 4 and 5 have cracks before the end of the 100 cycles. Only trays 2 and 6 compliant with standard NF EN 14527 have cracks during the tests carried out in the conditions imposed by standard NF EN 249.

The shower trays of this invention do not have any cracks during the various thermal shock tests according to the standards NF EN 14527 and NF EN 249. These tests demonstrate an improvement in the resistance to mechanical stresses of the trays that have been reinforced according to the method of this invention.

1. Method for preparing a reinforced structure comprising the following steps:
a) forming the structure to be reinforced in the form of a receptacle,
b) preparing a liquid thermosetting formulation at ambient temperature using a mixture of thermosetting polymer precursors, said liquid thermosetting formulation having a viscosity between 50 and 2000 mPa·s, preferably between 50 and 600 mPa·s,
c) pouring said liquid thermosetting formulation into said receptacle,
d) adding a filler into said thermosetting formulation poured during the step c), said filler having a granulometry between 0.05 and 10 mm, preferably between 0.1 and 3 mm, a moisture content less than 0.1%, and advantageously having a density greater than the density of said thermosetting formulation,
e) polymerising said thermosetting formulation with said filler, forming as such a reinforced structure, and
f) possibly, pouring a finishing layer constituted of said liquid thermosetting formulation prepared during the step b).

2. Method for preparing according to claim 1, characterised in that said structure is a thermoplastic material or a thermosetting resin.

3. Method for preparing according to claim 2, characterised in that said thermoplastic material is made of PMMA, of ABS or of ABS-PMMA.

4. Method for preparing according to claim 2, characterised in that said thermosetting resin is a polyurethane or polyester resin.

5. Method for preparing according to claim 1, characterised in that said mixture of precursors of thermosetting polymer comprises at least one polyol and at least one isocyanate.

6. Method for preparing according to claim 5, characterised in that the polyol/isocyanate weight ratio is between 100/10 and 100/300, preferably between 100/40 and 100/80.

7. Method for preparing according to claim 1, characterised in that said thermosetting polymer is a polyurethane.

8. Method for preparing according to claim 1, characterised in that said liquid thermosetting formulation prepared during the step b) further comprises a catalyst chosen from amines and metallic salts.

9. Method for preparing according to claim 1, characterised in that said liquid thermosetting formulation prepared during the step b) has a density between 0.3 and 2.4, preferably between 1 and 1.25.

10. Method for preparing according to claim 1, characterised in that said filler has a density greater than the density of said thermosetting formulation and is composed of materials chosen from thermoplastic materials, thermosetting materials, wood-meal, glass such as recycled glass, their by-products and mixtures thereof.

11. Method for preparing according to claim 1, characterised in that following the adding of the filler during the step d), the receptacle is put into vibration.

12. Method for preparing according to claim 1, characterised in that the filler added during the step d) is scraped over the entire surface of the thermosetting formulation poured into the receptacle.

13. Method for preparing according to claim 1, characterised in that it further comprises a step of applying an adhesion primer on the structure to be reinforced in the form of a receptacle following the step a) upstream of steps b) or c), when said structure is a thermoplastic material with a polyolefin base.

14. Method for preparing according to claim 1, characterised in that said reinforced structure is a bathtub, a washbasin, a wall panel or a shower tray or at least one portion of the latter.

15. Reinforced structure able to be obtained by the method of preparing according to claim 1, characterised in that said structure is a bathtub, a washbasin, a wall panel or a shower tray or at least one portion of the latter.
